(19) United States
(12) Patent Application Publication
(10) Pub. No.: US 2007/0142928 A1
(43) Pub. Date: Jun. 21, 2007

(54) Process management system for work machine environments

(76) Inventors: Eric Alan Moughler, Metamora, IL (US); Thomas Frank Doherty, Brisbane (AU)

Correspondence Address: CATERPILLAR/FINNEGAN, HENDERSON, L.L.P., 901 New York Avenue, NW, WASHINGTON, DC, 20001-4413, US

(21) Appl. No.: 11/304,617

(22) Filed: Dec. 16, 2005

(51) Int. Cl. G05B 11/01

(52) U.S. Cl. 700/12

(57) ABSTRACT

Systems and methods are disclosed for process management in a work machine environment. According to one embodiment, an exemplary disclosed process management system for a work machine environment is disclosed. The system includes a database configured to store information associated with a work machine environment. The system also includes a processor coupled to the database. The processor is configured to receive operation data from a work machine operating in the work machine environment. The processor is also configured to establish an operational change based on the received operation data. The processor is further configured to select, from a list of eligible operators stored in the database, an operator for operating the work machine. The processor is also configured to determine an operational change location based on the received operation data. The processor is further configured to schedule transportation for the operator to the operational change location.

### TECHNICAL FIELD

This application relates generally to a system for process management and, more particularly to systems and methods for managing processes within a work machine environment.

### BACKGROUND

In virtually any project environment, equipment and personnel productivity play an important role in the performance of one or more tasks associated with a project. Equipment and personnel productivity depends, in large part, on the effective management of logistical processes associated with the project environment. These processes generally include scheduling, deploying, maintaining, and managing personnel and equipment to complete the project. In addition, coordination and execution of certain processes, such as personnel operational changes, work machine maintenance, etc. are critical to minimizing overhead costs and project delays.

Traditionally, project managers or job-site foremen manually schedule personnel work shifts and equipment usage. However, this manual coordination may be time-intensive, complicated, and expensive. In addition, the traditional method for manual coordination of personnel work shifts and equipment usage may be particularly cumbersome for project environments involving large numbers of personnel and/or equipment.

One method for simplifying the scheduling of personnel in a work environment is described in U.S. Patent Publication No. 2005/0137925 (“the '925 publication”) to Lakritz et al. The '925 publication describes a computer-implemented method for automating the scheduling of resources into time slots based on certain limitations established by the resource, with consideration given to constraints provided by a user. Systems that employ the described method may generate diagnostic information that includes resource utilization, patterns of demand, and resource availability. The diagnostic information may be provided to the user to establish historical trends and assist in resolving potential scheduling conflicts.

Although the method described in the '925 publication may reduce the need for manual scheduling of resources by automatically scheduling resources into multiple time slots, it may still suffer from the same inefficiencies as other conventional methods. For example, the method described in the '925 publication does not monitor operation of a work environment during an operation of the shift. As a result, should one or more scheduled resources become unavailable and/or unproductive during the shift, the method described in the '925 publication does nothing to accommodate for this loss of productivity. Thus, any unexpected or otherwise unscheduled events that may affect the availability of a particular resource during an operation of a scheduled shift may not be properly accounted for by systems that employ the method described in the '925 publication.

Furthermore, because the method of the '925 publication does not use real-time work environment data in its scheduling process, the process management capabilities during operations of the work environment may be limited. For example, the method of the '925 publication generates a resource schedule based solely on user-input resource requirements, but does nothing to monitor the actual operating characteristics of the resource in the real-time (i.e., during operation of the work environment). As a result, should an operational aspect of the resource conflict with the user-input requirements, process schedules that are generated by the method of the '925 publication may be unreliable and/or invalid.

The disclosed systems and methods for managing processes in a work machine environment are directed towards overcoming one or more of the problems set forth above.

### SUMMARY OF THE INVENTION

Systems and methods are disclosed for process management in a work machine environment. According to one embodiment, an exemplary disclosed process management system for a work machine environment is disclosed. The system may include a database configured to store information associated with a work machine environment. The system may also include a processor coupled to the database. The processor may be configured to receive operation data from a work machine operating in the work machine environment. The processor may also be configured to establish an operational change based on the received operation data. The processor may be further configured to select, from a list of eligible operators stored in the database, an operator for operating the work machine. The processor may also be configured to determine an operational change location based on the received operation data. The processor may be further configured to schedule transportation for the operator to the operational change location.

In another embodiment, a method for process management of a work machine environment is disclosed. The method may include receiving, in a process management system, operation data from a work machine operating in a work machine environment. The method may also include establishing an operational change based on the received operation data. The method may further include selecting, from a list of eligible equipment operators, an operator for operating the work machine. The method may also include determining, based on the received operation data, an operational change location. The method may also include scheduling transportation for the operator to the operational change location.

In yet another embodiment, a method for scheduling operational change processes for a work machine environment is disclosed. The method may include receiving operation data from a work machine operating in a work machine environment. The method may also include determining, based on at least one of the received operation data and a predetermined maintenance schedule for the work machine, the eligibility of the work machine for an operational change. The method may further include selecting, from a list of eligible operators, a future operator for the work machine. The method may also include determining an operational change time and an operational change location based on at least one of the operation data and the predetermined maintenance schedule. The method may further include providing transportation for current and future operators between the operational change location and a predetermined pick-up location.

### BRIEF DESCRIPTION OF THE DRAWINGS

FIG. 1A illustrates an exemplary work machine environment consistent with certain disclosed embodiments;

FIG. 1B illustrates an exemplary disclosed process management system for use in the work machine environment of FIG. 1 consistent with certain disclosed embodiments;

FIG. 2 illustrates a flowchart depicting an exemplary disclosed operational change process consistent with certain disclosed embodiments; and

FIG. 3 illustrates a flowchart depicting an exemplary method associated with the operational change process depicted in FIG. 2.

### DETAILED DESCRIPTION

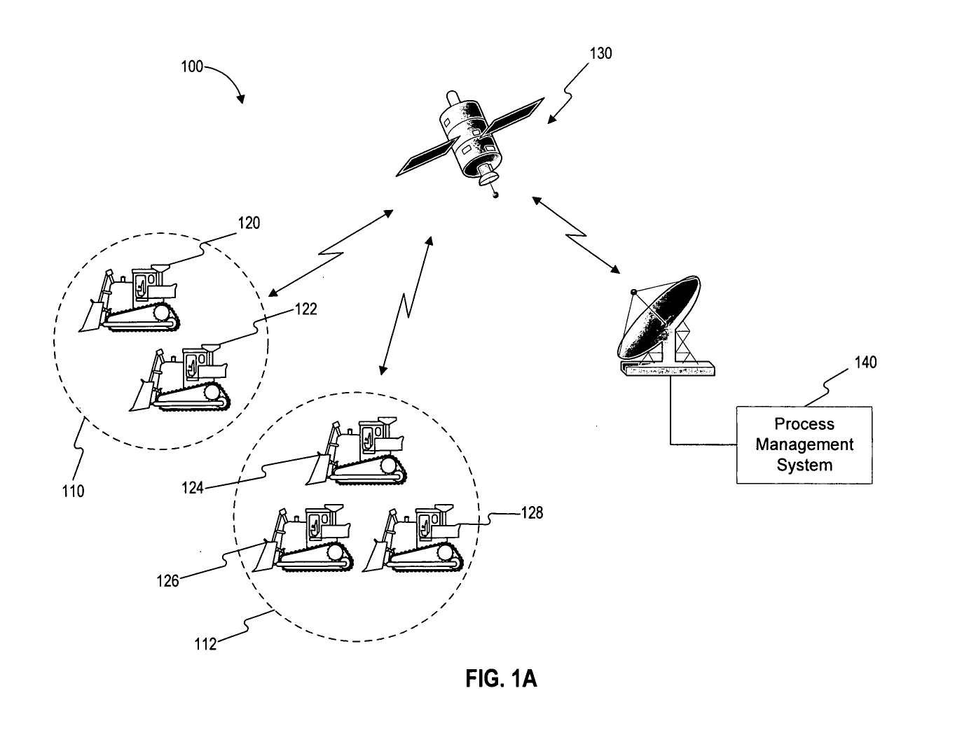

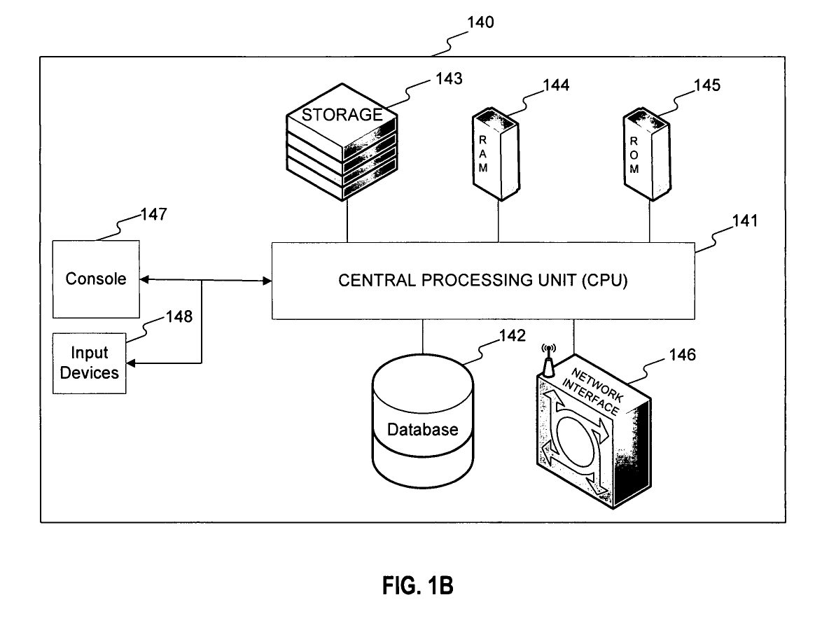

FIG. 1A illustrates an exemplary project environment 100 consistent with certain disclosed embodiments. Project environment 100 may include components that perform individual tasks that contribute to a work machine environment task associated with an industry, such as mining, construction, transportation, agriculture, manufacturing, or any other type of task associated with other types of industries. For example, project environment 100 may include one or more work machines 120-128 coupled to a process management system 140 via a communication network 130. The project environment 100 may be configured to monitor, collect, and filter information associated with an operation of one or more work machines 120-128 and distribute the information to one or more back-end systems, such as process management system 140. It is contemplated that additional and/or different components than those listed above may be included in project environment 100.

Work machines 120-128 may each be a fixed or mobile machine configured to perform an operation associated with project environment 100. Thus, work machine, as the term is used herein, refers to a fixed or mobile machine that performs some type of operation associated with a particular industry, such as mining, construction, farming, etc. and operates between or within project environments (e.g., construction site, mine site, power plants, etc.) A non-limiting example of a fixed machine includes an engine system operating in a plant or off-shore environment (e.g., off-shore drilling platform). Non-limiting examples of mobile machines include commercial machines, such as trucks, cranes, earth moving vehicles, mining vehicles, backhoes, material handling equipment, farming equipment, marine vessels, aircraft, and any type of movable machine that operates in a work environment. A work machine may be driven by a combustion engine or an electric motor. The types of work machines listed above are exemplary and not intended to be limiting. It is contemplated that project environment 100 may implement any type of work machine. Accordingly, although FIG. 1A illustrates work machines 120-128 as track-type tractor machines, each of work machines 120-128 may be any type of work machine operable to perform a particular function within project environment 100. Furthermore, it is contemplated that work machines 120-128 may include a first set of work machines 110 and a second set of work machines 112 for associating the operations of particular machines to groups of work machines. Furthermore, it is also contemplated that first and second sets of work machines may be located in separate work sites located remotely from each other, and each being geographically remote with respect to process management system 140.

In one embodiment, work machines 120-128 may perform tasks associated with work machine environment 100. As such, operators of work machines 120-128 may perform their respective tasks in shifts. A shift may include an operationally predefined period of time for which an operator and/or work machine operates within work machine environment 100. These shifts may be defined or associated with an operator of a given machine, one type of work machine, the type of task being performed, the type of work environment, etc. Further, operators of work machines 120-128 may each perform tasks for different shift durations. For example, work machine 120 may rotate operators every eight hours for two shifts, while work machine 122 may rotate operators every twelve hours. The disclosed embodiments contemplate work machines 120-128 being associated with different operators and work machine environment schedules, and shifts of varying durations. Each shift may include one or more operational changes. An operational change may include one or more events involving the changing of one or more work machines 120-128 and/or the operators of work machines 120-128 associated with work machine environment 100 such as, for example, rotating an operator from one work machine to another, replacing a current operator of a work machine with a future operator of the work machine, replacing a particular work machine associated with an operator with a different work machine, replacing one or more sets of work machines and/or operators performing a particular task, or any other type of event. Moreover, operational change data may be associated with one or more operational changes may include information related to the operational change such as, for example, a time, a location, directions, operator instructions, or any other type of data that may assist in facilitating the operational change. Operational change data may also include an operational change schedule that provides operational change times and/or locations for a plurality of work machines or work machine operators within work machine environment 100, based on a scheduled or unscheduled maintenance of a particular work machine. An operational change schedule may also include a matrix that shows each shift associated with work machines 120-128 and the corresponding equipment operators assigned to each work machine for each shift during a scheduled maintenance interval. The operational change schedule may be updated (periodically or continuously) to reflect the operations of each work machine operating in work machine environment 100, including unscheduled fault events (component failure, productivity decrease, etc.) associated with one or more work machines 120-128.

In one embodiment, each of work machines 120-128 may include on-board data collection and communication equipment to monitor, collect, and/or transmit information associated with an operation of one or more components of work machines 120-128. For example, work machines 120-128 may include, among other things, one or more monitoring devices (not shown) such as sensors, electronic control modules (not shown), etc. coupled to one or more data collection devices (not shown), and one or more communication devices (not shown), and/or any other such components for monitoring, collecting, and communicating information associated with the operation of work machines 120-128. Each of work machines 120-128 may also be configured to receive information from off-board systems, such as a process management system 140 or any other back-end communication system. The components described above are exemplary and not intended to be limiting. Accordingly, the disclosed embodiments contemplate each of work machines 120-128 including additional and/or different components than those listed above.

Communication network 130 may include any network that provides communication between each of work machines 120-128 and an off-board system, such as process management system 140. For example, communication network 130 may communicatively couple work machines 120-128 to process management system 140 across a wireless networking platform such as, for example, a satellite communication system. Alternatively and/or additionally, communication network 130 may include one or more broadband communication platforms appropriate for communicatively coupling one or more work machines 120-128 to process management system 140 such as, for example, cellular, Bluetooth, microwave, point-to-point wireless, point-to-multipoint wireless, multipoint-to-multipoint wireless, or any other appropriate communication platform for networking a number of components. Although communication network 130 is illustrated as a satellite-based wireless communication network, it is contemplated that communication network 130 may include wireline networks such as, for example, Ethernet, fiber optic, waveguide, or any other type of wired communication network.

Process management system 140 may include one or more computer systems of a business entity associated with work machine environment 100 such as a project management division, a maintenance division, an operations division, a payroll division, a personnel division, and any other entity that monitors, maintains, operates, schedules, and/or manages work machine environment 100. Process management system 140 may include any type of computer system such as, for example, a work station, a personal digital assistant (PDA), a mainframe, a network of computer systems, a laptop, and any other type of computer system or computer system network.

In one embodiment, process management system 140 may include hardware and/or software components that perform processes consistent with certain disclosed embodiments. For example, as shown in FIG. 1B, process management system 140 may include a central processing unit (CPU) 141, a database 142, a storage device 143, a random access memory (RAM) 144, a read-only memory (ROM) 145, a network interface 146, a console 147, and one or more input devices 148. The components described above are exemplary and not intended to be limiting. Furthermore, it is contemplated that process management system 140 may include alternative and/or additional components than those listed above. Further, process management system 140 may include components that store, for example, one or more software programs including instructions for executing process steps when executed by CPU 141.

CPU 141 may be one or more processors that execute instructions and process data to perform one or more processes consistent with certain disclosed embodiments. For instance, CPU 141 may execute software that enables process management system 140 to request, collect, and/or receive operation data from one or more work machines 120-128. Operation data may include data reflecting one or more parameters associated with the operation of one of work machines 120-128, such as, for example, status data (e.g., engine on/off, parked, stationary etc.), load weight, engine speed, engine temperature, oil pressure, location, engine hours, tire wear, component fatigue, fluid levels, pressure data, work machine position information, and any other parameter associated with the operation of a work machine. CPU 141 may also execute software that stores collected operation data in storage device 143. In addition, CPU 141 may execute software that enables process management system 140 to analyze operation data collected from one or more work machines 120-128, create operational change schedules based on the collected operation data, provide “real-time” customized scheduling reports detailing operational change data, monitor work machine operator usage statistics, and/or schedule maintenance based on the determined operational change data to adjust the efficiency of a work machine job-site.

Database 142 may contain work machine operation data, historical scheduling data, operator information, or any other information related to work machine environment 100. Database 142 may also include program tools for analyzing, sorting, filtering, and/or formatting data within database 142. Software programs may access database 142 to store different types of work machine data, such as historical relations or trends related to operator usage; work machine repair or maintenance history; productivity data of work machine 120; stress, wear, and/or fatigue data of components of work machine 120; historical scheduling data; operator licenses; operator preference data; and any other information related to the operation of work machine environment 100.

Storage devices 143, RAM 144, and ROM 145 may each be one or more computer-readable medium devices such as magnetic, electronic, and optical data computer-readable medium devices configured to store information, instructions, and/or program code used by CPU 141 of process management system 140. For example, storage devices 143 may include magnetic hard-drives, optical disc drives, floppy drives, or any other such information storing device. Random access memory (RAM) device 144 may include any dynamic storage device for storing information and instructions by CPU 141. RAM 144 also may be used for storing temporary variables or other intermediate information during execution of instructions to be executed by CPU 141. During operation, some or all portions of an operating system (not shown) may be loaded into RAM 144. In addition, read only memory (ROM) device 145 may include any static storage device for storing information and instructions by CPU 141.

Network interface 142 may include one or more elements configured to provide data communications between process management system 140, work machines 120-128, and/or one or more other backend systems (not shown). For example, network interface 142 may include one or more modulators, demodulators, multiplexers, demultiplexers, network communication devices, wireless devices, antennas, modems, or any other such devices configured to provide a communication interface between process management system 140 and remote systems or components. In one embodiment, network interface 146 may facilitate communication between process management system 140 and work machines 120-128 via communication network 130. Alternatively and/or additionally network interface 142 may provide communications between process management system 140 and other systems related to work machine environment 100 across various communication networks such as the Internet, a corporate intranet, satellite based systems, wireless systems, point-to-point networks, point-to-multipoint networks, multipoint-to-multipoint networks, or any other communication platform or medium for the transfer of information between two or more systems.

Process management system 140 may interface with a user via console 147 and one or more input devices 148. In particular, console may provide a graphical user interface (GUI) to display information to users of process management system 140. Console 20 may include any appropriate type of display device such as a computer monitor. Input device 148 may be provided for users to input information into process management system 140. Input device may include any type of device for inputting data into a process management system such as, a mouse, a voice recognition system, a disc drive, or any other optical, magnetic, wireline, or wireless input device.

Process management system 140 may be configured to remotely coordinate operational changes for job-sites employing numerous work machines and/or work machine operators. Alternatively and/or additionally, process management system 140 may remotely coordinate operational changes for multiple job-sites operating in geographically distinct areas or single job-sites encompassing large geographical areas. Furthermore, process management system 140 may be configured to provide operational change data to one or more external users or systems associated with work machine environment 100. For example, process management system 140 may provide an operational change schedule to one or more users or user systems associated with one or more job-sites such as, a project manager, a dispatcher or dispatch system, or any other system that uses operational change information related to one or more job-sites.

Process management system 140 may also be configured to receive, analyze, and distribute operation data from one or more work machines 120-128 via communication network 130. For example, during operations in work machine environment 100, process management system 140 may receive operation data from one or more work machines 120-128 over communication network 130. In addition, process management system 140 may analyze the operation data and transmit analysis results and/or commands associated with the analysis results to work machine 120-128 via communication network 130.

Process management system 140 may further be configured to collect preference information associated with one or more operators of work machines 120-128 associated with work machine environment 100. For example, process management system 140 may receive preference information input by an operator or operator system from input device 148 or received from network interface 146. Preference information may include any information related to an operator associated with work machine environment 100 such as, for example, work machine preferences, shift preferences, seniority data, license data, desired work hours, or any other type of data related to one or more operators. Operator data may be received from an operator or operator system via input device 148 or network interface 146. As another example, project management system 140 may receive preferences information from one or more computer systems and/or execute software that generates, collects, and/or determines preferences information for one or more work machine operators.

In certain embodiments, process management system 140 may be configured to perform processes, when executed by CPU 141, to schedule operational change times for one or more work machines 120-128 and work machine operators based on data stored in database 142. For instance, process management system 140 may compare the real-time operation data received from each of work machines 120-128 to historical operation data corresponding to each of work machines 120-128 stored in database 142 to establish one or more proposed operational change times for each of work machines 120-128. Process management system 140 may compare the proposed operational change times with operator preference information stored in database 142 to assign an operator to each work machine for the proposed operational change time. In addition, each operator may be paired with a particular work machine for the scheduled operational change time and assigned a unique operator key for that work machine at the scheduled operational change time. Thus, operators and work machines may be assigned operational change times based on real-time work machine operation data, historical operation data stored in database 142, and/or operator preference data. It is also contemplated that, in certain embodiments, operational change times and work machine assignments may be assigned according to additional and/or different criteria than those described above.

Process management system 140 may also be configured to establish operational change locations based on position data received from one or more work machines 120-128. An operational change location may be a geographic area within environment 100 that is a dedicated area for operators to shut down and exit their respective work machines at the end of their shift. Further, an operational change location may be a geographic area within environment 100 that is a dedicated area for new operators to begin their shift operating respective work machines.

For example, if work machines selected for an operational change are clustered in a particular section of a job-site, process management system 140 may establish an operational change location in that general section. Alternatively and/or additionally if work machines selected for an operational change are geographically dispersed, process management system 140 may select an alternate location requiring the least amount of travel for each of work machines 120-128. It is also contemplated that process management system 140 may use additional and/or different criteria than those listed above to establish the operational change location. For instance, process management system 140 may designate operational change locations based on predetermined operational change staging areas defined by a project manager regardless of work machine location.

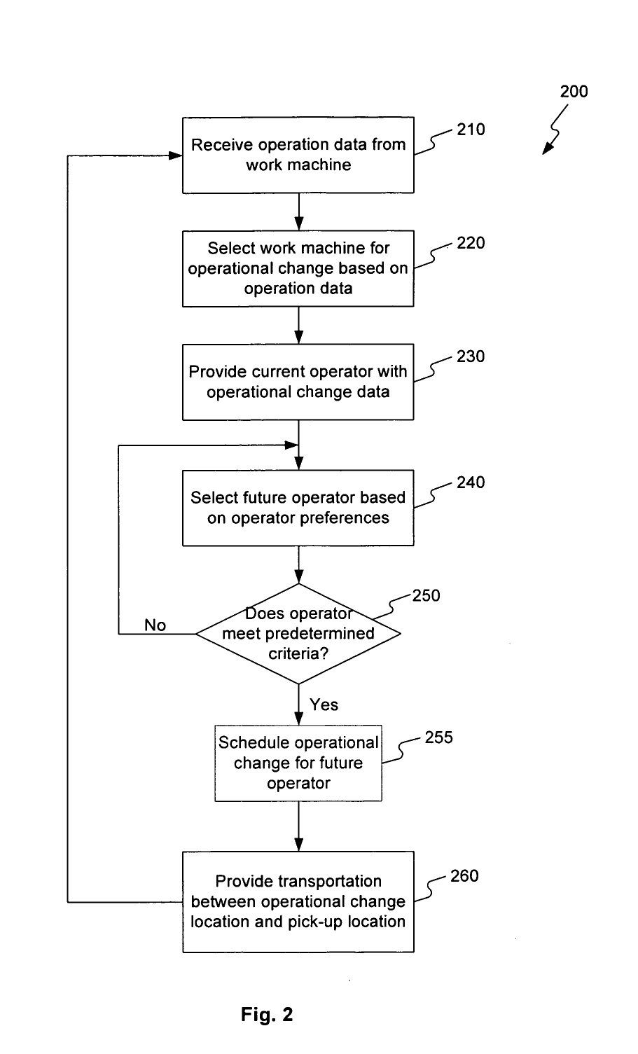

As explained, methods and system consistent with certain disclosed embodiments provide an environment that allows users to manage job-site processes such as equipment and personnel scheduling, operational changes, maintenance, etc. using real-time operation data collected from work machines 120-128. FIG. 2 shows a flowchart of an exemplary operational change process 200 consistent with certain disclosed embodiments. Initially, process management system 140 may receive operation data from work machines 120-128 in a manner consistent with the descriptions above (Step 210). For example, process management system 140 may receive operation data associated with one or more work machines 120-128, or associated with one or more sets of work machines 110-112 as work machines operate within work machine environment 100.

Process management system 140 may analyze the received data and select one or more work machines 120-128, sets of work machines 110-112, or any combination thereof eligible for operational change based on the received operation data (Step 220). For example, CPU 141 associated with process management system 140 may execute software that compares operation data or portions thereof (e.g., one or more parameters) associated with work machines 120-128 to information stored in database 142 to determine if one or more work machines 120-128 may require an operational change. For instance, CPU 141 may determine that an oil pressure of a particular work machine is outside of a predetermined threshold range. CPU 141 may subsequently analyze information stored in database 142 and determine that work machine 120 is due for scheduled maintenance. Based on this determination, process management system 140 may select work machine 120 for an operational change.

Once one or more work machines have been selected for an operational change, process management system 140 may notify the current operator of the work machine and may provide operational change data to the operator over communication system 130 (Step 230). Furthermore, operational change data may be provided to the operator through any operator interface device, such as a work machine display console, a communication device located on the work machine, a paging or cellular device, or any other type of communication device for providing data to an operator of work machines 120-128 during operation of work machines 120-128. Operational change data may include information associated with a given work machine 120-128 and/or an operator of the given work machine. For instance, following the above example, process management system 140 may provide an operator of work machine 120 with operational change data including instructions for delivering work machine 120 to a particular maintenance facility (e.g., the one located nearest to the work machine) at a particular time. Furthermore, process management system 140 may provide additional and/or different status change data than that listed above such as, for example, directions to the status change site, alternate times for work machine drop-off, alternate locations for maintenance facilities, priority tasks to be performed prior to operational change, or any other such data related to the operational change.

Process management system 140 may also select, from a list of operators stored in database 142, a future operator to replace the current operator of the work machine based on one or more preferences stored in database 142 (Step 240). As explained above, preferences may include information related to each operator such as, for example, work machine licenses, seniority data, shift preferences (i.e., first shift, second shift, etc.), work machine preferences (e.g., track-type tractor, excavator, etc.), or any other such operator information. Following the example above, process management system 140 may select a future operator of work machine based on the seniority of a particular operator and a selection of the operator to work a particular shift.

Once the operator has been selected, process management system 140 may verify the operator information to determine whether the selected operator is associated with a profile that meets predetermined criteria for operating the work machine. For example, project management system 140 may check the future operator's profile to determine whether the operator has obtained the necessary licenses, insurance, and training required to operate the work machine (Step 250). Should process management system 140 determine that the selected operator does not meet the predetermined criteria (Step 250: No), process management system 140 may select a different operator.

Alternatively, if process management system 140 determines that the selected operator meets the predetermined criteria to operate the particular work machine (Step 250: Yes), it may schedule an operational change for the future operator (Step 255). This may include, for example, notifying the future operator via email, phone, web, dispatcher, etc.; displaying operational change data one a display (e.g., display 147), etc.; or any other suitable notification method. Next, project management system 140 may schedule, arrange, and/or provide the appropriate transportation to and from the job-site (Step 260). In one embodiment, multiple operators may be scheduled for operational changes at substantially the same time and location. As a result, process management system 140 may select appropriate transportation arrangements to accommodate the number of operators participating in the scheduled operational change.

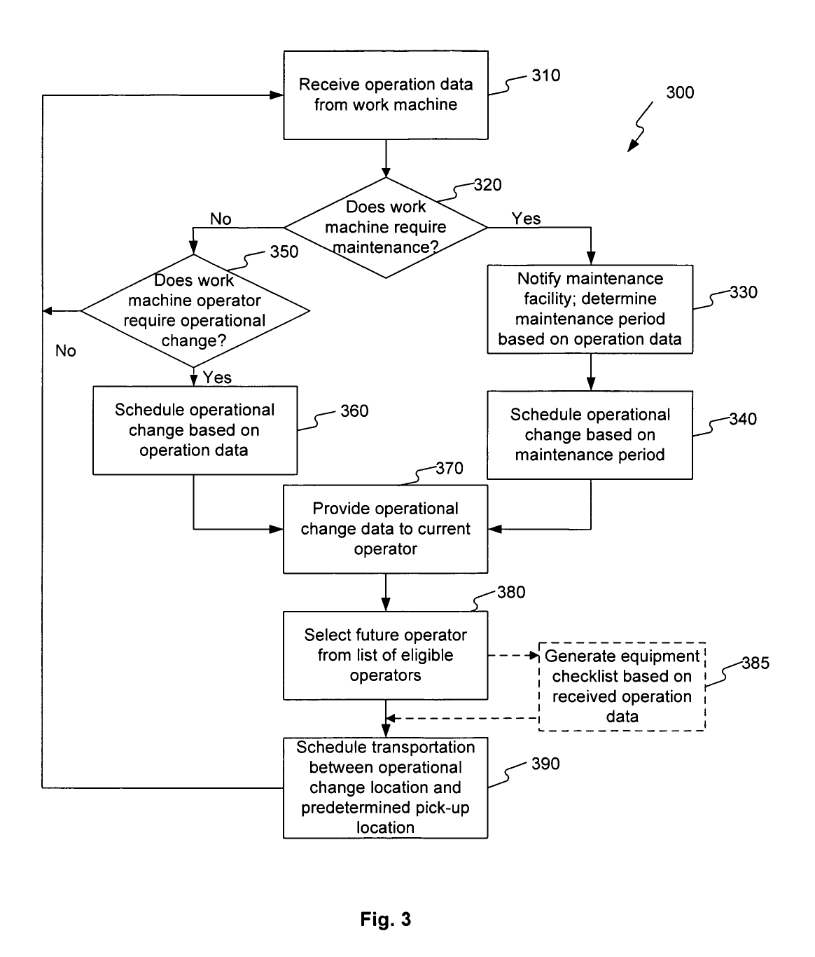

As explained, process management system 140 may process operation data received from work machines 120-128 and schedule, coordinate, and manage equipment and personnel within work environment 100 based on operation data received from the work machines. As illustrated in flowchart 300 of FIG. 3, an exemplary disclosed process management method for scheduling operational changes associated with work environment 100.

Initially, project management system 140 may receive operation data from one or more work machines 120-128 in a manner similar to that described above (Step 310). CPU 141 may store the received operation data in database 142 and/or storage device 143.

Process management system 140 may then determine whether one or more work machines 120-128 require maintenance according to the received operation data from work machines 120-128 (Step 320). It is contemplated that this determination may be made based on real-time operation data, historical operation data, or a combination of real-time operation data and historical operation data. For instance, if a critical alarm related to one or more components of work machine 120 is received, process management system 140 may determine that work machine 120 requires maintenance. Alternatively and/or additionally, process management system 140 may determine from historical operation data that the work machine 120 requires a scheduled routine maintenance check-up. It is also contemplated that, according to some embodiments, process management system 140 may determine that one or more of work machines 120-128 do not require maintenance. Further, project management system 140 may receive input from a user identifying the maintenance status of a given work machine.

If process management system 140 determines that a particular work machine requires maintenance (Step 320: Yes), process management system 140 may notify a maintenance facility to schedule maintenance and determine a maintenance period for the work machine (Step 330). For instance, process management system 140 may transmit the operation data and/or any associated analysis to a maintenance facility with a request to schedule work machine maintenance. As a result of the scheduled maintenance, process management system 140 may determine an approximate time for an operational change based on the maintenance period. The maintenance period may be determined by the maintenance facility. Alternatively and/or additionally, process management system 140 may determine the estimated maintenance period based on historical data stored in database 142.

Upon scheduling maintenance and determining the maintenance period, process management system 140 may schedule the operational change based on the maintenance period (Step 340). For instance, process management system 140 may schedule an operational change time and location based on the project maintenance time and the location of the maintenance facility. As a result, the operational change may be coordinated around completion of the maintenance of one or more work machines. In accordance with this embodiment, process management system 140 may coordinate the operational change to minimize the work machine down-time resulting from work machine maintenance.

If the work machine is determined not to require maintenance (Step 320: No), process management system 140 may determine whether the work machine operator requires an operational change based on the received operation data (Step 350). For example, process management system 140 may analyze operation data to determine if one or more operators require an operational change based on one or more operator criteria such as, for example, the number of operator hours worked, a request from the operator, the end of a previous operator shift, or any other such operator parameter. Should the operator of a particular work machine not require an operational change (Step 350: No), process management system 140 may determine that an operational change is not required for the particular machine.

Should process management system 140 determine that an operator of a particular work machine requires an operational change (Step 350: Yes), an operational change may be scheduled based on the operator data (Step 360). For example, according to one exemplary embodiment, process management system 140 may determine that an operator of a work machine has worked for a maximum allowable time, indicating that the operator may be eligible for an operational change. Thus, process management system 140 may schedule the operational change based on operator data collected from work machines 120-128 when compared to predetermined operator usage threshold data (e.g., contract shift requirements, safety standards, etc.)

Once an operational change has been scheduled, process management system 140 may provide operational change data to the current operator of the work machine, corresponding to the scheduled operational change (Step 370). As explained above operational change data may include information related to the operational change such as, for example, a time, a location, directions, operator instructions, or any other type of data that may assist in managing the operational change. Process management system 140 may transmit operational change data to each operator of a work machine that is scheduled for an operational change indicating, among other things, an operational change time and location for the respective work machines 120-128.

According to one embodiment, process management system 140 may select a future operator from a list of eligible equipment operators stored in database 142 (Step 380). In addition, process management system 140 may optionally generate a safety checklist based on the received operation data to be completed by the operators prior to operating the work machines after the operational change (Step 385). In addition to generating safety checklists, process management system 140 may be configured to provide work assignments to one or more work machine operators based one the status of a project associated with work environment 100. A safety checklist may include a manual or automated checklist completed by each operator prior to the operation of a respective work machine at the beginning of the shift. Safety checklist, as the term is used herein, may include any checklist that an operator completes prior to the beginning of a shift that includes inspection verification information for one or more components associated with a respective work machine. This information may include, visual, electrical, or computerized verification of mechanical, electrical, and/or hydraulic components and systems which may be indicative of inappropriate or inefficient operation of the work machine.

Process management system 140 may schedule transportation between an operational change location and a predetermined pick-up location (Step 390). Alternatively and/or additionally, process management system 140 may schedule transportation for work machine operators between multiple operational change locations and/or the predetermined pick-up location. According to one exemplary embodiment, CPU 141 associated with process management system 140 may execute processes to schedule a transportation route associated with an operational change vehicle once the operational change locations have been established. For the purposes of the present disclosure, a pick-up location may include a designated area, such as a project staging area, where one or more future operators gather to be transported to the operational change location determined by process management system 140. Furthermore, the pick-up location may drop off one or more operators of work machines 120-128 after the completion of their respective shift.

According to one exemplary embodiment, process management system 140 may select one or more work machines eligible for an operational change based on operation data collected from work machines 120-128 and/or historical operation data stored in database 142. For example, operation data may select first and second work machines 120 and 122, respectively, for an operational change based on a low fuel warnings received from the machines. Thus, operational changes may be governed by one or more conditions of one or more work machines 120-128. Alternatively and/or additionally, process management system 140 may schedule work machines for operational changes according to a predetermined shift schedule (e.g., every 8 hours, etc.) stored in database 142 associated with each work machine and/or licensed operators of a given work machine. It is also contemplated that process management system 140 may schedule operational changes based on maintenance required by one or more work machines 120-128. Therefore, if a particular work machine requires scheduled maintenance in the near future, process management system 140 may schedule the operational change to correspond to the scheduled maintenance.

In accordance with another exemplary embodiment, process management system 140 may determine operational changes based on “real-time” operator data. For example, if an operator of work machine 120-128 requests an operational change during a shift, process management system 140 may analyze the request, select an alternate operator, schedule an operational change, and arrange transportation to and from the operational change location in response to the operator request. As a result, if an unexpected operator event requires an emergency operational change, process management system 140 may appropriately evaluate and/or respond to the request.

### INDUSTRIAL APPLICABILITY

Methods and systems consistent with the disclosed embodiments schedule and manage time-sensitive processes in a work machine environment 100 based on real-time data collection from one or more work machines 120-128. Work machine environments that employ processes and elements consistent with certain disclosed embodiments allow a user to define scheduling preference information, such as operator information, scheduled maintenance information, etc., to govern how process management system 140 coordinates operational change schedules. Additionally, certain embodiments enable project management system 140 to generate and provide equipment checklists and work machine assignments to operators based on the received operation data.

Although the disclosed embodiments are described in association with a work machine environment 100, the disclosed systems and methods for job-site process management may be applicable to any environment where it may be desirable to manage equipment, personnel, and process schedules based on real-time operation data related to operations within the environment. Specifically, the disclosed job-site process management system may manage processes associated with a work machine environment, coordinate personnel and equipment availability, and adjust work machine and operator processes based on operation data collected during operations of work machine environment 100.

The process management system described above enables a computer system to coordinate operational change, maintenance, and personnel schedules in response to work machine operation data received in real-time. Thus, inefficiencies associated with scheduling delays may be reduced, as a project manager is no longer required to analyze data received from the work machines. Instead, the disclosed embodiments enable a computer system to receive, analyze, and modify process schedules, particularly operational change, maintenance, and personnel schedules, within a single computer-based system and transmit the information to one or more systems associated with work machine environment 100. Thus, embodiments associated with the disclosed process management system may reduce or eliminate the inefficiencies associated with project managers collecting, analyzing, and modifying work environment processes manually.

Furthermore the embodiments associated with the disclosed process management system may enhance project management capabilities of work environments relying on resource scheduling. For example, because the disclosed process management system integrates real-time data collection capabilities with personnel, equipment, and maintenance scheduling, project managers may receive up-to-the-minute schedule updates, operational change information, operator and work machine status details, and/or maintenance facility schedules. Thus, the disclosed process management system may provide project managers real-time operational change and maintenance data that may allow project managers to make adjustments, if required, to subsequent shift schedules to increase shift productivity.

It will be apparent to those skilled in the art that various modifications and variations can be made to the disclosed process management system without departing from the scope of the disclosed embodiments. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A process management system for a work machine environment, comprising:
a database configured to store information associated with the work machine environment; and
a processor coupled to the database and configured to:
receive operation data from a work machine operating in the work machine environment;
establish an operational change for the work machine based on the received operation data;
select, from a list of eligible operators stored in the database, a future operator for operating the work machine; and
determine an operational change location based on the received operation data.

2. The system of claim 1, wherein the process management system is further configured to schedule transportation for the future operator to the operational change location.

3. The system of claim 1, wherein the process management system is further configured to provide operational change data to the work machine based on the received operation data, wherein the operational change data includes the operational change location.

4. The system of claim 3, wherein the operation data includes operator data corresponding to an ID key assigned to a current operator of the work machine.

5. The system of claim 1, wherein the process management system is further configured to select the work machine from among a plurality of work machines to participate in the operational change based on the received operation data.

6. The system of claim 1, wherein the received operation data includes data reflecting a location of the work machine.

7. The system of claim 6, wherein the process management system is further configured to determine the operational change location based on the location of the work machine.

8. The system of claim 1, wherein the received operation data includes one or more parameters associated with the work machine.

9. The system of claim 8, wherein the one or more parameters includes at least one of a fuel level, a component status, and a fluid level.

10. The system of claim 9, wherein the process management system is further configured to select the work machine from a plurality of work machines to participate in the operational change based on the one or more parameters associated with the work machine.

11. The system of claim 1, wherein the process management system is further configured to generate a safety checklist for the work machine based on the received operation data.

12. A method for managing a work machine environment, comprising:
receiving, in a process management system, operation data from a work machine operating in the work machine environment;
establishing an operational change for the work machine based on the received operation data;
selecting, from a list of eligible equipment operators, a future operator for operating the work machine;
determining, based on the received operation data, an operational change location; and
scheduling transportation for the future operator to the operational change location.

13. The method of claim 12, further including providing operational change data including the operational change location to the work machine.

14. The method of claim 13, wherein the operation data includes operator data gathered from the work machine corresponding to an ID key assigned to a current operator of the work machine.

15. The method of claim 12, further including selecting the work machine from among a plurality of work machines to participate in the operational change based on the received operation data.

16. The method of claim 12, wherein the received operation data includes data reflecting a location of each of the plurality of work machines.

17. The method of claim 16, wherein determining the operational change location includes determining the operational change location based on the location of the work machine.

18. The method of claim 12, further including generating a safety checklist for the work machine based on the received operation data.

19. The system of claim 12, further including providing a work assignment to the operator prior to the operational change.

20. A method for scheduling operational change processes for a work machine environment comprising:
receiving operation data from a work machine operating in a work machine environment;
determining, based on at least one of the received operation data and a predetermined maintenance schedule for the work machine, the eligibility of the work machine for an operational change;
selecting, from a list of eligible operators, a future operator for the work machine; and
determining an operational change time and an operational change location based on at least one of the operation data and the predetermined maintenance schedule.

21. The method of claim 20, further including scheduling transportation for current and future operators between the operational change location and a predetermined pick-up location.

22. The method of claim 20, wherein determining that the work machine is eligible for the operational change includes determining that the work machine requires maintenance based on the received operation data.

23. The method of claim 22, further including:
determining a maintenance period based on the received operation data received from the work machine;
modifying the operational change data based on the maintenance period; and
providing the modified operational change data to the future operator of the work machine.

24. The method of claim 20, wherein determining that the work machine is eligible for the operational change includes determining that the current operator of the work machine has completed a predetermined task using the work machine.

25. The method of claim 20, wherein determining that the work machine is eligible for the operational change includes receiving an operational change request from the current operator of the work machine.

26. The method of claim 20, further including generating a safety checklist to be completed by the future operator prior to operating the work machine.
